(19) United States
(12) Patent Application Publication
(10) Pub. No.: US 2010/0161308 A1
(43) Pub. Date: Jun. 24, 2010

(54) Multi-structured memory

(75) Inventor: Robert Norman, Pendleton, OR (US)

Correspondence Address: UNITY SEMICONDUCTOR CORPORATION, 255 SANTA ANA COURT, SUNNYVALE, CA, 94085-4511, US

(73) Assignee: UNITY SEMICONDUCTOR CORPORATION, Sunnyvale, CA (US)

(21) Appl. No.: 12/653,852

(22) Filed: Dec. 18, 2009

Related U.S. Application Data
(60) Provisional application No. 61/203,430, filed on Dec. 22, 2008.

(51) Int. Cl. G06F 9/455; G06F 12/00

(52) U.S. Cl. 703/23; 711/154; 711/103; 711/105; 711/E12.001

(57) ABSTRACT

Multi-structured memory is described, including a first memory configured to emulate a first memory type, a second memory configured to emulate a second memory type, the first and second memories disposed in one or more third dimensional memory arrays, and an interface configured to access the first memory or the second memory for data operations. The one or more third dimensional memory arrays are formed on the same component and can be fabricated BEOL on top of a substrate (e.g., a silicon wafer or other semiconductor substrates) including active circuitry (e.g., CMOS devices) fabricated FEOL and operative to perform data operations on the memory arrays and to communicate with external systems configured to access the memory arrays. The third dimensional memory(s) can include two-terminal non-volatile re-writeable cross-point memory arrays including two-terminal non-volatile re-writeable memory cells having their respective terminals electrically coupled with a pair of conductive array lines.

### FIELD OF THE INVENTION

The present invention relates generally to semiconductors and memory technology. More specifically, multi-structured memory is described.

### BACKGROUND

Depending on the technology and architecture, memory systems (“systems”) can be designed in various ways. Some conventional methodologies involve building a system using components that meet the design needs of the system requirements. In conventional systems, different memory types are needed to form the system, including random access memory (RAM), Flash memory, read-only memory (ROM), and various other memory technologies.

RAM is a volatile memory that can be used to temporarily store data for processing systems. A volatile memory is a memory that loses its contents when power is removed from the memory. Some conventional techniques use RAM, including static RAM (SRAM) and dynamic RAM (DRAM). SRAM includes several transistors arranged as a flip-slop to store each bit of memory. DRAM includes a transistor and a capacitor used to store each bit of memory. Since capacitors leak charge, a DRAM is constantly refreshed to retain the data stored in the DRAM. DRAM has fewer components and is less complex and less expensive, but SRAM is faster and does not use a refresh cycle.

Flash memory is a type of non-volatile memory. A non-volatile memory is a memory that retains its contents when power is removed from (i.e., not applied to) the memory. Flash memory, therefore, is useful for providing quick data access upon booting. However, Flash memory typically uses complex logic, including state machines and other logic devices, to read and program a memory. Flash memory is also slower than RAM since Flash memory includes a complex interface and requires programming in blocks of bits. In some conventional solutions, Flash memory can be implemented as NOR and NAND types. NOR Flash is used for code storage and execution, typically in small quantities, while NAND Flash is typically used for high capacity data storage. NAND Flash offers higher densities, additional capacity on a given die size, and is less expensive than NOR Flash. Alternatively, ROM has a set of memory locations that can be read, but the contents of these memory locations are fixed, typically at the time the ROM is created.

In some conventional systems, a processor executes code from memory. This operating memory can be ROM or NOR Flash, both of which allow random access based on direct address selection. In addition, the processor needs fast temporary memory. Conventionally, there is an internal SRAM for fast access and a second larger external memory having larger capacity at slightly slower access speeds. The instruction memory resides in ROM or NOR Flash memory, and can be copied from these memories at power on and placed in DRAM. DRAM advantages over ROM or Flash memory and offers larger capacity at lower cost than SRAM. In addition, there is a need to store data, either temporarily or permanently, from data path movement. This data can be stored in DRAM or NAND Flash. Typically, a controller acts as the interface between the processor and the DRAM or NAND Flash. This controller allows for conversion from processor bus structure to memory, in addition to providing an external port access such as direct memory access (DMA).

As processor and memory storage requirements increase, there is also an increasing demand to implement increased circuitry with a decrease in components. Cost, size, and power requirement reductions are important goals for conventional systems. However, it is difficult to combine both DRAM and Flash memory on one component since they are fabricated using different process methods. Further, it is difficult to obtain the exact desired memory components since DRAM and Flash memory do not work well with conventional hardware compiler methods and thus require handcrafted design approaches. Due to the different memory types and different process steps involved with fabricating conventional systems, combinations of memory types in a single component (e.g., a die, a package, or a chip) are difficult. Still further, it is difficult to facilitate the optimization of a design, thus requiring design sacrifices that reduce the efficiency, performance, or size.

Thus, a solution for different memory types on the same component without the limitations of conventional techniques is needed.

### BRIEF DESCRIPTION OF THE DRAWINGS

Various examples are disclosed in the following detailed description and the accompanying drawings.

FIG. 1 depicts an exemplary memory system;

FIG. 2 depicts an alternative exemplary memory system;

FIG. 3 depicts another alternative exemplary memory system;

FIG. 4 depicts yet another alternative exemplary memory system;

FIG. 5 further depicts an exemplary memory system;

FIG. 6 depicts an exemplary cross-sectional view of a vertically configured non-volatile third-dimensional memory array;

FIG. 6A depicts an example of memory cells positioned in a two-terminal cross-point array;

FIG. 7 depicts an integrated circuit including memory cells disposed in a single memory array layer or in multiple memory array layers and fabricated over a substrate that includes active circuitry fabricated in a logic layer;

FIG. 8A depicts a cross-sectional view of an integrated circuit including a single layer of memory fabricated over a substrate including active circuitry fabricated in a logic layer;

FIG. 8B depicts a cross-sectional view of an integrated circuit including vertically stacked layers of memory fabricated over a substrate including active circuitry fabricated in a logic layer;

FIG. 9 depicts a vertically stacked layers of memory in which conductive array lines are shared by memory cells in adjacent layers;

FIG. 10 depicts an integrated circuit including vertically stacked layers of memory with shared conductive array lines fabricated over a substrate including active circuitry fabricated in a logic layer; and

FIG. 11 depicts top plan views of a wafer processed FEOL to form a plurality of base layer die including active circuitry and the same wafer subsequently processed BEOL to form one or more layers of memory directly on top of the base layer die where the finished die can subsequently be singulated, tested, and packaged into integrated circuits.

Although the previous drawings depict various examples of the invention, the invention is not limited by the depicted examples. It is to be understood that, in the drawings, like reference numerals designate like structural elements. Also, it is understood that the depictions in the FIGS. are not necessarily to scale.

### DETAILED DESCRIPTION

Various embodiments or examples may be implemented in numerous ways, including as a system, a process, an apparatus, or a series of program instructions on a computer readable medium such as a computer readable storage medium or a computer network where the program instructions are sent over optical, electronic, or wireless communication links. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims, and numerous alternatives, modifications, and equivalents are encompassed. Numerous specific details are set forth in the following description in order to provide a thorough understanding. These details are provided as examples and the described techniques may be practiced according to the claims without some or all of the accompanying details. For clarity, technical material that is known in the technical fields related to the examples has not been described in detail to avoid unnecessarily obscuring the description.

In some examples, techniques such as those described herein enable emulation of multiple memory types for implementation on a single component such as a wafer, substrate, or die. U.S. patent application Ser. No. 11/095,026, filed Mar. 30, 2005, published as U.S. Pub. No. 2006/0171200, and entitled “Memory Using Mixed Valence Conductive Oxides,” is herein incorporated by reference for all purposes and describes non-volatile third dimensional memory elements that may be arranged in a two-terminal, cross-point memory array. New memory structures are possible with the capability of this third dimensional memory array. In at least some embodiments, a two-terminal memory element or memory cell can be configured to change conductivity when exposed to an appropriate voltage drop across the two-terminals. The memory element can include an electrolytic tunnel barrier and a mixed valence conductive oxide. A voltage drop across the electrolytic tunnel barrier can cause an electrical field within the mixed valence conductive oxide that is strong enough to move oxygen ions out of the mixed valence conductive oxide and into the electrolytic tunnel barrier. When certain mixed valence conductive oxides (e.g., praseodymium-calcium-manganese-oxygen perovskites and lanthanum-nickel-oxygen perovskites) change valence, their conductivity changes. Additionally, oxygen accumulation in certain electrolytic tunnel barriers (e.g., yttrium stabilized zirconia) can also change conductivity. If a portion of the mixed valence conductive oxide near the electrolytic tunnel barrier becomes less conductive, the tunnel barrier width effectively increases. If the electrolytic tunnel barrier becomes less conductive, the tunnel barrier height effectively increases. Both mechanisms can be reversible if the excess oxygen from the electrolytic tunnel barrier flows back into the mixed valence conductive oxide. A memory can be designed to exploit tunnel barrier height modification, tunnel barrier width modification, or both. The technology allows for the emulation of other memory technologies by duplicating the interface signals and protocols, while accessing the third dimensional memory array. The third dimensional memory array may emulate other types of memory, providing memory combinations within a single component.

In some embodiments, an electrolytic tunnel barrier and one or more mixed valence conductive oxide structures do not need to operate in a silicon substrate, and, therefore, can be fabricated (e.g., back-end-of-the-line BEOL) above circuitry being used for other purposes (e.g., fabricated front-end-of-the-line FEOL). Further, a two-terminal memory cell can be arranged as a cross point such that one terminal is electrically coupled with an X-direction line (or an “X-line”) and the other terminal is electrically coupled with a Y-direction line (or a “Y-line”). A third dimensional memory can include multiple memory cells vertically stacked upon one another, sometimes sharing X-direction and Y-direction lines in a layer of memory, and sometimes having isolated lines. When a first write voltage, VW1, is applied across the memory cell (e.g., by applying ½ VW1 to the X-direction line and ½-VW1 to the Y-direction line), the memory cell can switch to a low resistive state. When a second write voltage, VW2, is applied across the memory cell (e.g., by applying ½ VW2 to the X-direction line and ½-VW2 to the Y-direction line), the memory cell can switch to a high resistive state. Memory cells using electrolytic tunnel barriers and mixed valence conductive oxides can have VW1 opposite in polarity from VW2.

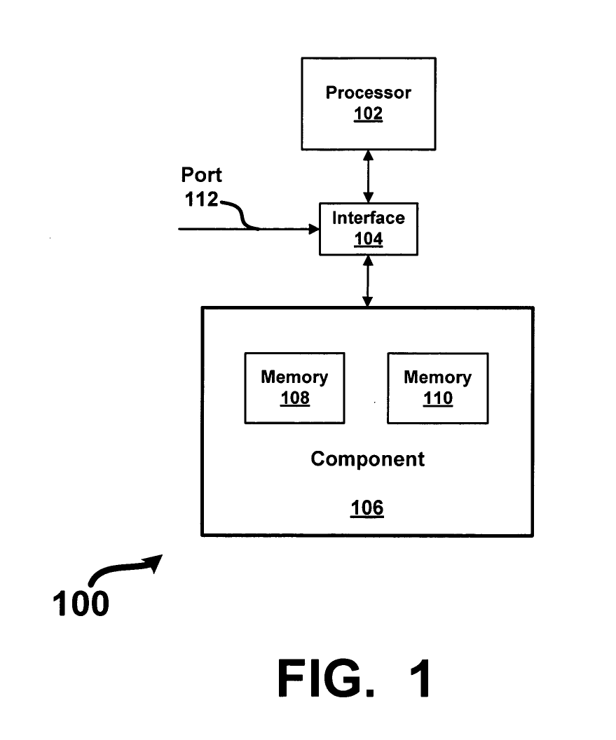

FIG. 1 illustrates an exemplary memory system. Here, system 100 includes processor 102, interface 104, component 106, memory 108, memory 110, and port 112. In some examples, memory in system 100 may be implemented to emulate random access memory (RAM), dynamic random access memory (DRAM), static random access memory (SRAM), read-only memory (ROM), Flash memory, and other memory types. Memory 108 and memory 110 may be formed on the same component 106. Interface 104 may couple processor 102 with memory 108, memory 110, or both. Interface 104 may couple port 112 to memory 108, memory 110, or both. In some examples, port 112 may be a direct memory access (DMA) port. Although one port 112 is shown in FIG. 1, in other examples, there may be more than one port coupled to interface 104.

In FIG. 1, memory 108 may be configured to emulate a memory type. Memory 110 may be configured to emulate another memory type. The memory types emulated by memory 108 and memory 110 may include NOR Flash memory, NAND Flash memory, SRAM, DRAM, ROM, and others. In some examples, memory 108 may be configured to emulate NAND Flash memory, and memory 110 may be configured to emulate NOR Flash memory. In other examples, memory 108 may be configured to emulate NOR Flash memory and memory 110 may be configured to emulate DRAM. In yet other examples, memory 108 may be configured to emulate SRAM, and memory 110 may be configured to emulate DRAM. In still other examples, memories 108-110 may be configured differently and are not limited to the examples provided above.

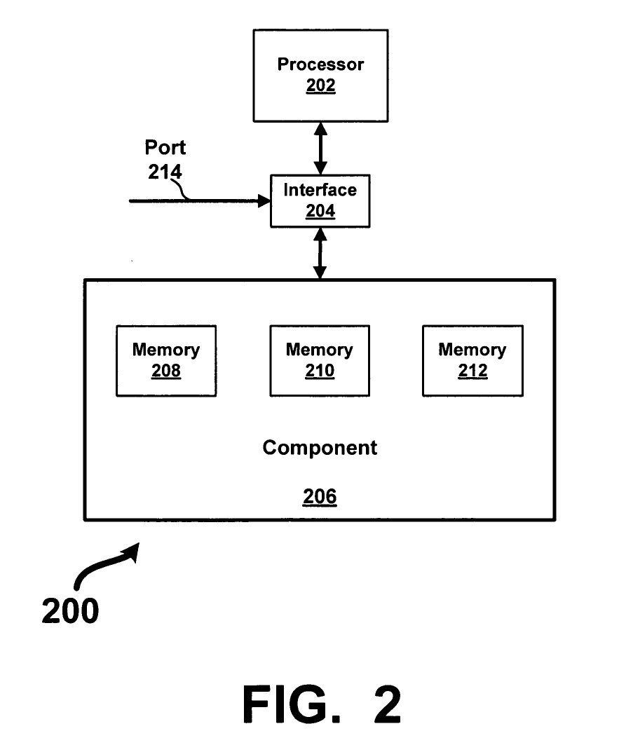

FIG. 2 illustrates an alternative exemplary memory system. Here, system 200 includes processor 202, interface 204, component 206, memory 208, memory 210, memory 212, and port 214. In some examples, memory in system 200 may be implemented as RAM, DRAM, SRAM, ROM, Flash memory, and others. Memory 208, memory 210, and memory 212 may be formed on the same component 206. Interface 204 may couple processor 202 with memory 208, memory 210, memory 212, or a combination thereof. Interface 204 may couple port 214 to memory 208, memory 210, memory 212, or a combination thereof. In some examples, port 214 may be a DMA port. Although one port 214 is shown in FIG. 2, in other examples, there may be more than one port coupled directly or indirectly to interface 204.

In FIG. 2, memory 208 may be configured to emulate a memory type, memory 210 may be configured to emulate another memory type, and memory 212 may be configured to emulate yet another memory type. The memory types emulated by memory 208, memory 210, and memory 212 may include NOR Flash memory, NAND Flash memory, SRAM, DRAM, ROM, and other memory types. In some examples, memory 208 may be configured to emulate SRAM, memory 210 may be configured to emulate NOR Flash memory, and memory 212 may be configured to emulate NAND Flash memory. In other examples, memory 208 may be configured to emulate SRAM, memory 210 may be configured to emulate NOR Flash memory, and memory 212 may be configured to emulate DRAM. In still other examples, system 200 and the described elements may be designed and implemented differently and are not limited to the examples shown.

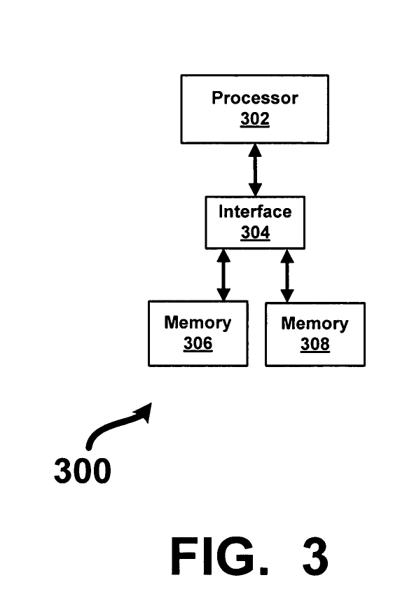

FIG. 3 illustrates another alternative exemplary memory system. Here, system 300 includes processor 302, interface 304, memory 306, and memory 308. In some examples, memory in system 300 may be implemented as RAM, DRAM, SRAM, ROM, Flash memory, and other memory types. Interface 304 may be configured for sharing between memory 306 and memory 308, coupling processor 302 with memory 306 and memory 308.

In some examples, interface 304 may be configured for sharing between memory 306 and memory 308, regardless of the emulated memory types. The memory types emulated by memory 306 and memory 308 may include NOR Flash memory, NAND Flash memory, SRAM, DRAM, ROM, and other memory types. Since NOR Flash and SRAM have substantially similar interfaces, common interface 304 may be used to accommodate both functions, and a user may assign address ranges for the desired memory use of NOR Flash or SRAM. The same interface 304 may be configured to emulate a ROM interface by providing a non-volatile register that may be set to block a write operation after the memory is initially written. For the interface to Flash memory, a Busy status signal is used for write and erase functions. Interface 304 may be configured to emulate the Flash memory interface for usage with a third dimensional memory array such as that described above in U.S. patent application Ser. No. 11/095,026, already incorporated herein by reference and for all purposes. If memory 306 and memory 308 were memory types NOR Flash and SRAM, a non-volatile register may be added to the design to represent the boundary address between the NOR Flash and the SRAM. This allows the Busy status to be utilized during write and erase operations in the NOR Flash address space, but not during write and erase operations in the SRAM address space. For the NAND Flash interface, interface 304 may be configured to emulate the control sequence and status registers of a NAND Flash device.

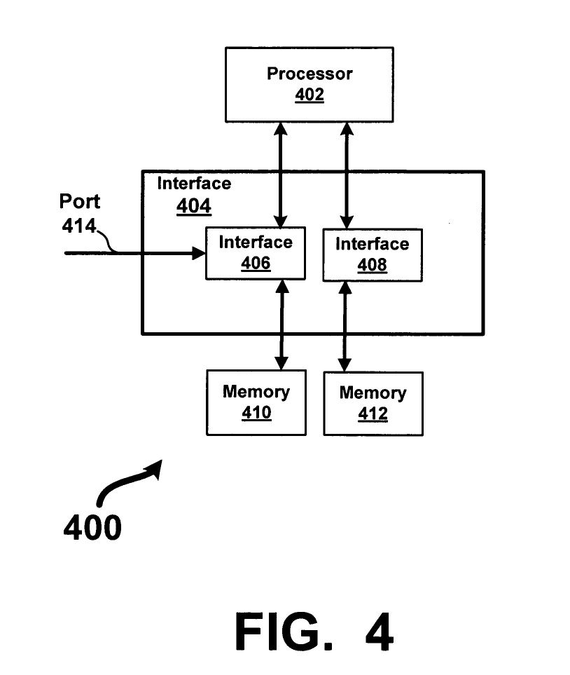

Using the structure described above in connection with FIG. 3, interface pin usage is minimized, and thus a connection to processor 302 is provided. Processor 302 may execute out of direct memory (e.g., SRAM or NOR Flash memory types) and access data files from indirect memory (e.g., DRAM or NAND Flash memory types). This design may be utilized for a stand-alone chip where both program and data access occurs through the processor. Other structures for a memory interface may be implemented, such as those shown in FIG. 4. In other examples, system 300 and the above-described elements may be varied and are not limited to the functions, structures, configurations, or implementations provided.

FIG. 4 illustrates yet another alternative exemplary memory system. Here, system 400 includes processor 402, interface 404, interface 406, interface 408, memory 410, memory 412, and port 414. In some examples, memory in system 400 may be implemented as RAM, DRAM, SRAM, ROM, Flash memory, and others. As an example, interface 404 includes interface 406 and interface 408. Interface 406 may couple processor 402 with memory 410. Likewise, interface 408 may couple processor 402 to memory 412. Interface 406 may couple port 414 to memory 410. In some examples, port 414 may be a DMA port. Although one port 414 is shown in FIG. 4, in other examples, there may be more than one port coupled to interface 406.

Here, memory 410 and memory 412 have separate interfaces, unlike the example shown and described above in connection with FIG. 3. Although memory 410 and memory 412 are formed on substantially the same component, memory 410 is coupled to interface 406, while memory 412 is coupled to interface 408. Using this structure, memory usage is possible on one component, thus allowing data to be accessible from a DMA controller or another port. In other examples, system 400 and the above-described elements may be varied and are not limited to the functions, structures, configurations, or implementations provided.

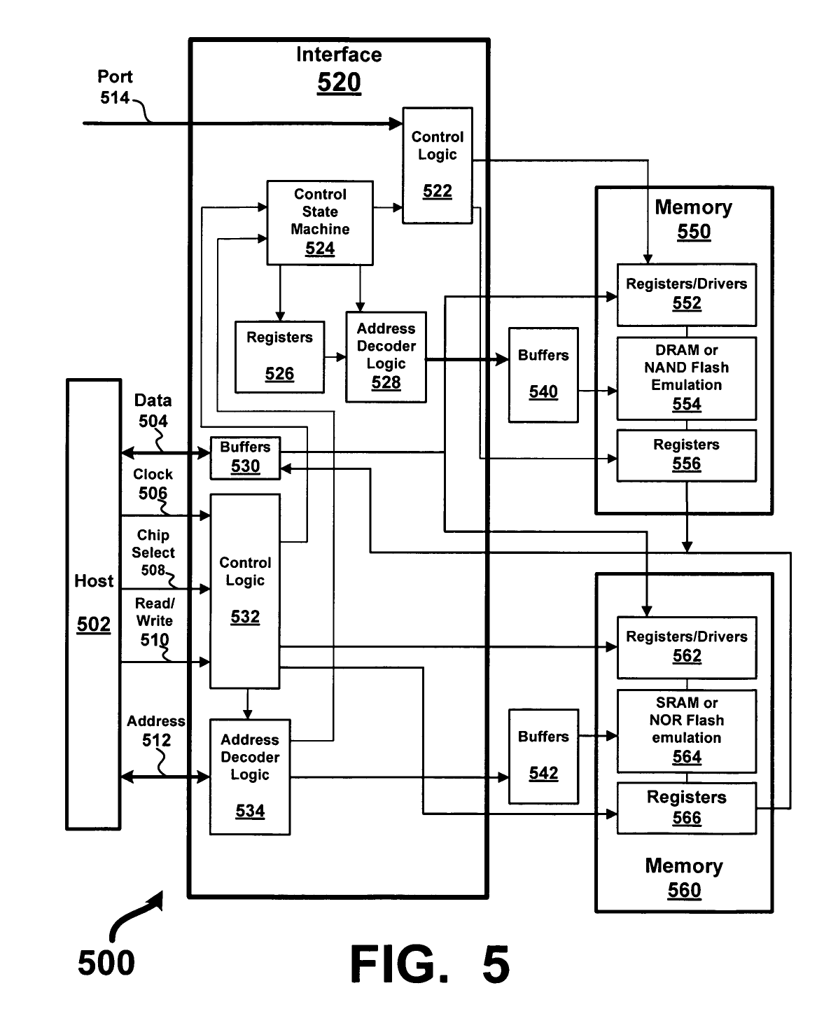

FIG. 5 further illustrates an exemplary memory system. Here, system 500 includes host 502, data 504, clock 506, chip select 508, read/write 510, address 512, port 514, interface 520, control logic 522, control state machine 524, registers 526, address decoder logic 528, buffers 530, control logic 532, address decoder logic 534, buffers 540, buffers 542, memory 550, registers/drivers 552, DRAM or NAND Flash emulation 554, registers 556, memory 560, registers/drivers 562, SRAM or NOR Flash emulation 564, and registers 566. Interface 520 may couple host 502 with memory 550, memory 560, or both. Interface 520 may couple port 514 to memory 550. In some examples, port 514 may be a DMA port and control logic 522 may be DMA logic. Although one port 514 is shown in FIG. 5, in other examples, there may be more than one port coupled to interface 520.

Here, an exemplary shared interface, such as that described above in connection with FIG. 3, is shown in greater detail. Further, system 500 may be configured to include DMA logic in a shared interface between memories (e.g., memory 550, memory 560) that are configured to emulate different volatile and non-volatile memory types (e.g., DRAM, NOR, SRAM, Flash, and others). In some examples, the indirect memory (e.g., DRAM or NAND Flash memory) may be accessed through the external port 514 or via the host 502 interface.

In some examples, interface 520 may contain multiple interface pins. Data 504 may be configured to receive data from the host and to transmit data from memory 550 and memory 560. Clock 506 may be configured to provide or receive a clock signal for synchronous or asynchronous uses by system 500 and the described elements. Here, chip select 508 may be configured to select memory 550 or memory 560 for access. Read/write 510 may be configured to receive a signal that indicates whether memory 550 or memory 560 is in a read state or a write state. Address 512 may be configured to receive an address from host 502. In some examples, address 512 may be a single pin configured to receive the address in series. In other examples, address 512 may be a bus configured to receive the address in parallel.

In some examples, interface 520 may be configured to include multiple blocks of logic configured for interfacing with host 502 and controlling memory 550 and memory 560. In FIG. 5, control logic 522 and control logic 532 are configured to control memory 550 and memory 560, respectively. Control logic 522 is configured to control memory 550, which, in this example, is an indirect memory emulating DRAM or NAND Flash memory. Control logic 532 is configured to control memory 560, which, in this example, may be a direct memory emulating SRAM or NOR Flash memory. Host 502 may access both memory 550 and memory 560 through a common interface 520. In other examples, host 502 may be a processor or processing circuit, device, system, apparatus, element, or the like. Here, common interface 502 allows memory material, such as that described above, to be used for accessing memories 550-560, which may be configured to emulate different memory types. In other words, although memories 550-560 are emulating different memory types, the memory material used in a third-dimensional structure (i.e., memory array), as described above in U.S. patent application Ser. No. 11/095,026, enables die size reduction without a corresponding loss in capacity or performance over that of SRAM, DRAM, NAND, and others. Further, the non-volatile nature of the memory material described allows data retention without loss when power is removed, disabled, or otherwise not provided to system 500.

As an example, transaction flow initiated by host 502 may occur by sending signals or data to interface 520. Buffers 530 receive data, which is passed to registers/drivers 552 and registers/drivers 562. Control logic 532 receives signals, which are used to control registers/drivers 562 and registers 566. Further, address decoder logic 534 receives an address and sends the address data (e.g., an address within memory 550, memory 560, and others) to buffers 542. In some examples, addresses may be of various sizes (16, 32, 64, 128, 256-bit, and the like) and are not limited to any particular bit length or size.

Buffers 542 then relay the address to SRAM or NOR Flash emulation 564. In some examples, control state machine 524 receives signals from control logic 532 and address decoder logic 534 in order to send appropriate control signals to control logic 522, registers 526, and address decoder logic 528. Control logic 522 controls registers/drivers 552 and registers 556 accordingly. Address decoder logic 528 sends address data (e.g., an address within memory 550, memory 560, and others) to buffers 540. Buffers 540 relay the address to DRAM or NAND Flash emulation 554. Depending on which memory was accessed, buffers 530 may receive data from memory 550 through registers 556 or buffers 530 may receive data from memory 560 through register 566. This data is sent back to host 502. In other examples, system 500 and the above-described elements may be varied and are not limited to the functions, structures, configurations, or implementations provided.

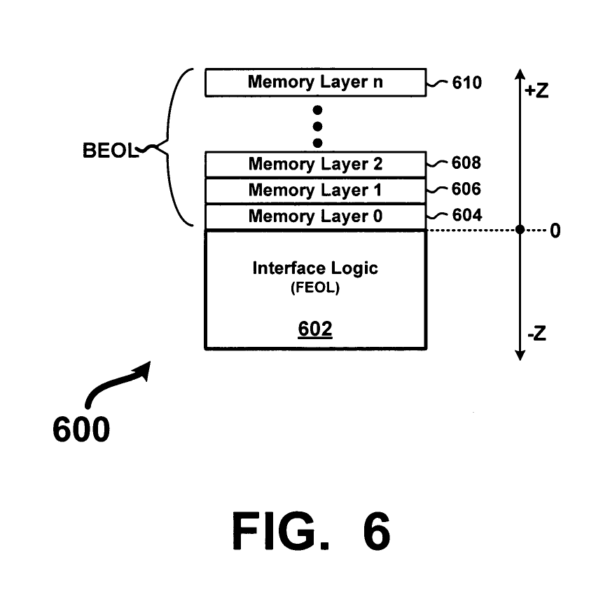

FIG. 6 illustrates an exemplary cross-sectional view of a vertically configured non-volatile third-dimensional memory array. In some examples, system 600 includes interface logic 602, which may be vertically configured with one, two, three, or multiple (i.e., “n”) memory array layers 604-610. Each of memory array layers 604-610 may be used for implementing different aspects of a memory system (e.g., system 500 (FIG. 5), and others). For example, a base layer of system 600 (e.g., interface logic 602) may be used to implement control logic or an interface between memory elements in a memory system (e.g., interface 520, control logic 522, and the like), while memory array layer 604-610 may be used to implement memory. Further, memory array layers 604-610 may be used to implement ‘n’ number of memory types, where each of memory array layers 604-610 are configured to emulate a different type of memory (e.g., SRAM, DRAM, NOR, NAND, Flash, and others). Still further, each of memory array layers 602-610 may be configured, formed, fabricated, or otherwise implemented entirely or partially to emulate a memory type. In other examples, memory array layers 604-610 may be implemented as the same memory type. In still other examples, the number of memory array layers 604-610 may be varied to include more, fewer, or different layers than those shown and described.

As an example, logic (i.e., control logic 522 (FIG. 5)) of interface 520 (FIG. 5) may be formed in memory array layer 602. Further, memory 550 (FIG. 5) may be formed in memory array layer 604 and memory 560 (FIG. 5) may be formed in memory layer 606. In still other examples, more, fewer, or different layers than those shown may be used. In other examples, system 600 and the above-described elements may be varied and are not limited to the functions, structures, configurations, or implementations provided.

FIG. 6A depicts an example of arrayed memory cells according to various embodiments of the invention. The aforementioned memory layers 604-610 described in regards to FIG. 6 are denoted as array 699 in FIG. 6A. In this example, a memory cell 680 includes a memory element 603. Memory cell 680 further includes the terminals 605 and 607 with the memory element 603 electrically in series with the terminals 605 and 607. Terminals 605 and 607 can be electrically coupled with or can be formed as electrodes 612 and 616. The electrodes (612, 616) can be made from an electrically conductive material including but not limited to, platinum (Pt), gold (Au), silver (Ag), iridium (Ir), iridium oxide (IrOₓ), ruthenium (Ru), palladium (Pd), aluminum (Al), and the like.

In at least some embodiments, memory cell 680 can include a non-ohmic device (NOD) 614, which, in turn, can be formed on the memory element 603 (e.g., either above or below memory element 603). NOD 614 can be a “metal-insulator-metal” (MIM) structure that includes one or more layers of electronically insulating material that are in contact with one another and sandwiched between metal layers (e.g., electrodes), or NOD 614 can be a pair of diodes connected in a back-to-back configuration. U.S. patent application Ser. No. 11/881,473, filed Jul. 26, 2007, now U.S. Published Application No. 2009-0027976 A1, and entitled “Threshold Device For A Memory Array” and U.S. patent application Ser. No. 12/283,339, filed Sep. 11, 2008, now U.S. Published Application No. 2009-0016094 A1, and entitled “Selection Device for Re-Writable Memory” are both hereby incorporated by reference in their entirety and for all purposes and describe metal-insulator-metal and diode based non-ohmic devices. NOD 614 can be another type of selection device and the present invention is not limited to the examples disclosed herein. The NOD 614 and the memory element 603 are electrically in series with each other and with the terminals 605 and 607. Memory cell 680 can be formed between conductive array lines, such as array lines 692 and 694. Thus, memory cell 680 can be formed in an array of other memory cells. The array can be a cross-point array 699 including a plurality of the conductive array lines 692 and 694, and a plurality of the memory cells 680. For example, array lines 692 can be electrically coupled with the electrodes 612 of the memory cells 680 and/or may be in contact with a surface 612s of the electrodes 612 and array lines 694 can be electrically coupled with the electrodes 616 of the memory cells 680 and/or may be in contact with a surface 616s of the electrodes 616. A memory cell 680′ is selected for a data operation (e.g., read or write operation) by applying select voltages (e.g., read voltages, write voltages, program voltages, or erase voltages) to its respective conductive array lines 692′ and 694′.

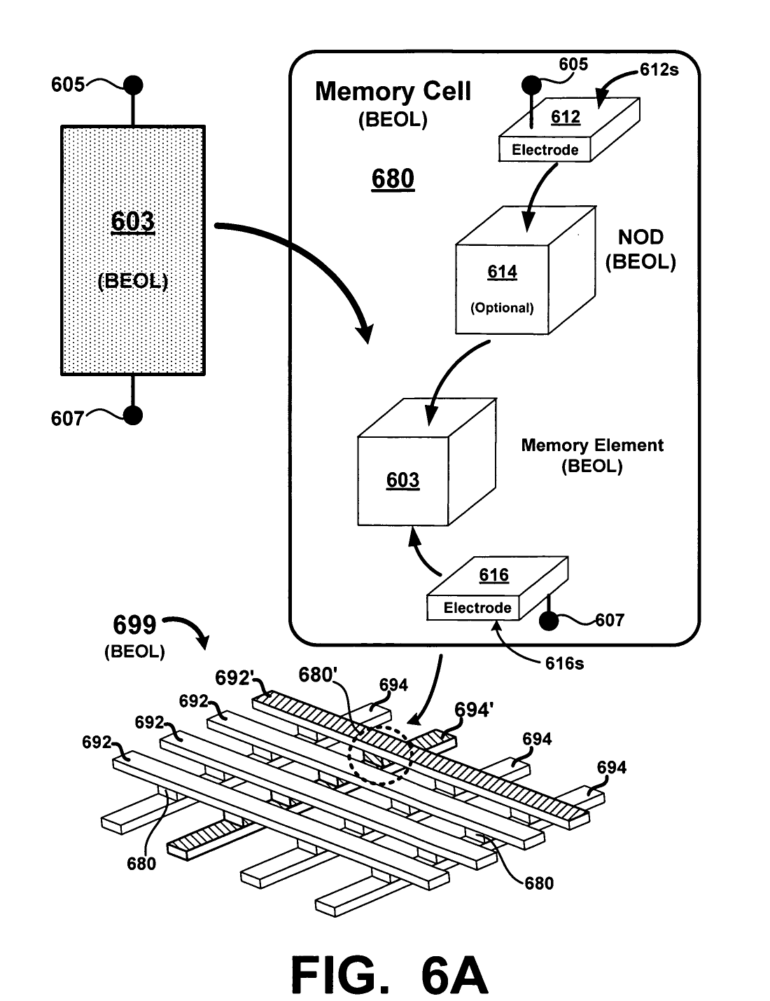

Turning now to FIG. 7, an integrated circuit 700 can include non-volatile and re-writable memory cells 680 disposed in a single layer 710 or in multiple layers 740 of memory, according to various embodiments of the invention. The single 710 or multiple 740 layers of memory can be fabricated BEOL. In this example, integrated circuit 700 is shown to include either multiple layers 740 of memory (e.g., layers 742a, 742b, . . . 742n) or a single layer 710 of memory 712 formed on (e.g., fabricated above) a base layer 720 (e.g., a silicon wafer). The base layer 720 can be fabricated FEOL with the single or multiple layers of memory 710 and/or 740 fabricate BEOL on top of the base layer 720. In at least some embodiments, each layer of memory (712, or 742a, 742b, . . . 742n) can include the cross point array 699 fabricated (e.g., BEOL) and having conductive array lines (692, 694) arranged in different directions (e.g., substantially orthogonal to one another) to access memory cells 680 (e.g., two-terminal memory cells). For example, conductors 692 can be X-direction array lines (e.g., row conductors) and conductors 694 can be Y-direction array lines (e.g., column conductors). Base layer 720 (e.g., substrate 602 in FIG. 6) can include a bulk semiconductor substrate upon which circuitry, such as memory access circuits (e.g., address decoders, drivers, sense amps, etc.) can be formed. For example, base layer 720 may be a silicon (Si) substrate upon which the active circuitry 732 and 734 are fabricated. The active circuitry 732 and 734 includes analog and digital circuits configured to perform data operations on the memory layer(s) that are fabricated above the base layer 720. An interconnect structure (not shown) including vias, plugs, thrus, and the like, may be used to electrically communicate signals from the active circuitry 730 to the conductive array lines (692, 694).

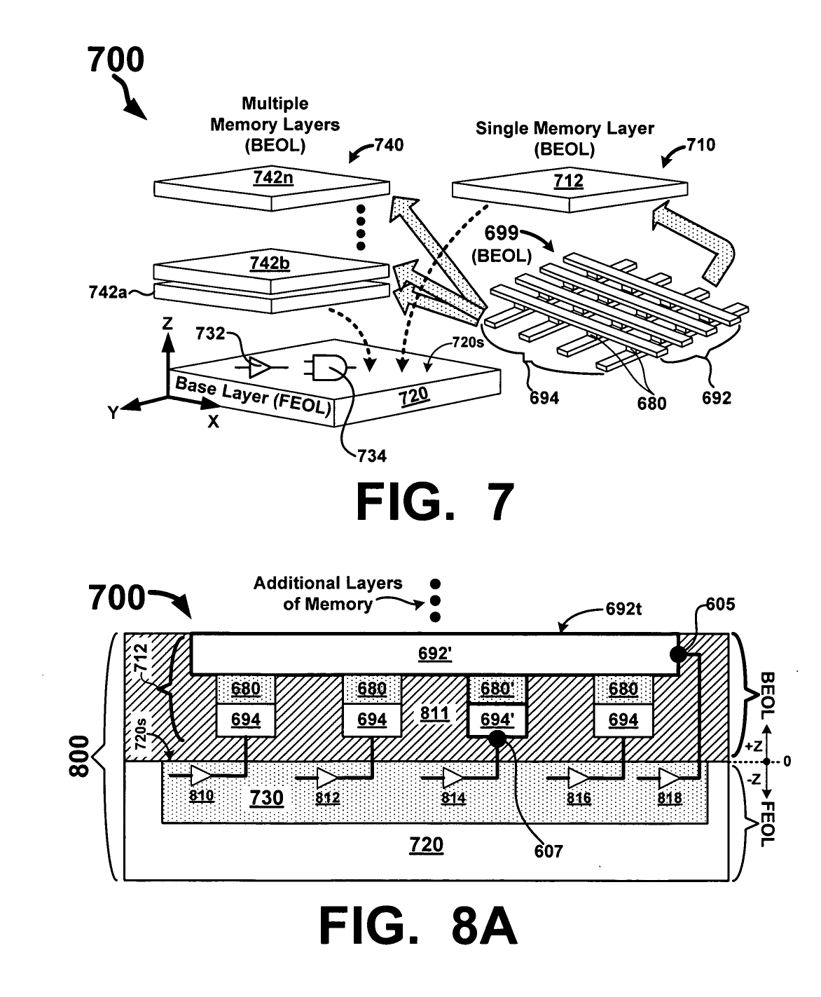

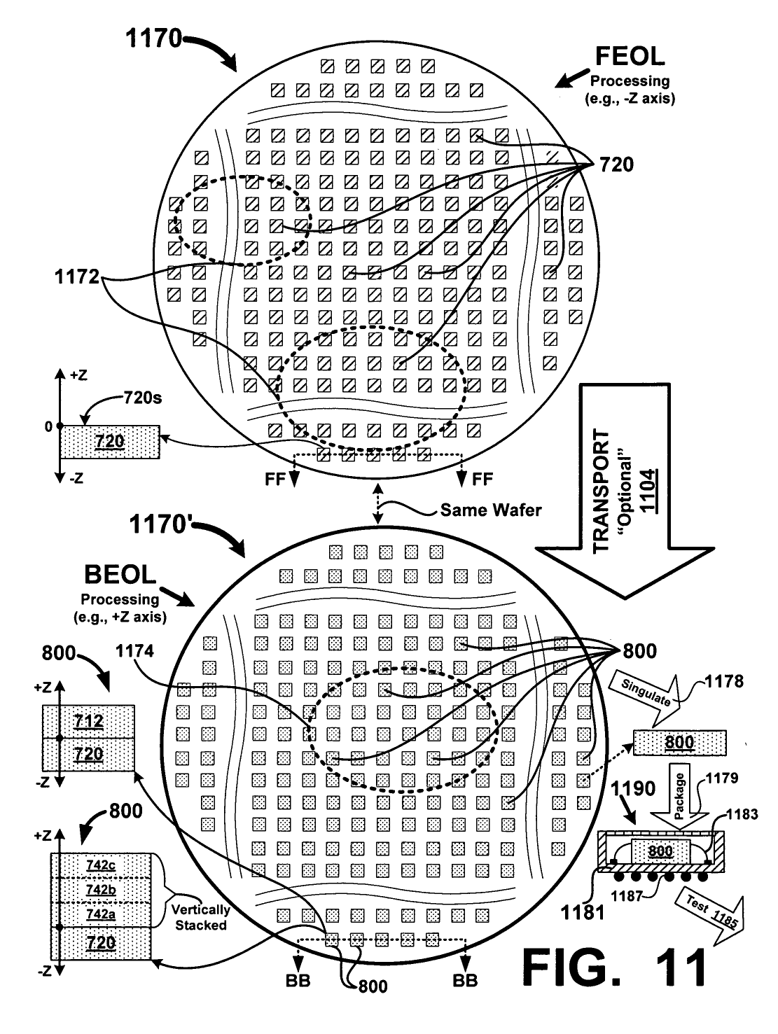

Reference is now made to FIG. 8A, where integrated circuit 700 includes the base layer 720 and active circuitry 732 and 734 fabricated on the base layer 720. As one example, the base layer 720 can be a silicon (Si) wafer and the active circuitry 732 and 734 can be microelectronic devices formed on the base layer 720 using a CMOS fabrication process. The memory cells 680 and their respective conductive array lines (692, 694) can be fabricated on top of the active circuitry 732 and 734 in the base layer 720. Those skilled in the art will appreciate that an inter-level interconnect structure (not shown) can electrically couple the conductive array lines (692, 694) with the active circuitry 732 and 734 which may include several metal layers. For example, vias can be used to electrically couple the conductive array lines (692, 694) with the active circuitry 732 and 734. The active circuitry 732 and 734 may include but is not limited to the circuitry portions depicted in FIG. 2 for performing margin restore on the fuse element 200, address decoders, sense amps, memory controllers, data buffers, direct memory access (DMA) circuits, voltage sources for generating the read and write voltages, just to name a few. For example, active circuits 810-818 can be configured to apply the select voltage potentials (e.g., read and write voltage potentials) to selected conductive array lines (692′, 694′) for selected memory cell 680′ via terminals 605 and 607 that are electrically coupled with outputs of active circuits 814 and 818 respectively. Moreover, active circuits 810-818 may be coupled with the conductive array lines (692′, 694′) to sense the read current I_{R} from selected memory cells 680′ during a read operation and the sensed current can be processed by active circuits 810-818 to determine the conductivity profiles (e.g., the resistive state) of the selected memory cells 680′. In some applications, it may be desirable to prevent un-selected array lines (692, 694) from floating. The active circuits 810-818 can be configured to apply an un-select voltage potential (e.g., approximately a ground potential) to the un-selected array lines (692, 694). A dielectric material 811 (e.g., SiO₂) may be used where necessary to provide electrical insulation between elements of the integrated circuit 700. Collectively, the FEOL base layer 720 and the one or more layers of BEOL memory 712 can be referred to as a die 800 as will be described in greater detail below in regards to FIG. 11.

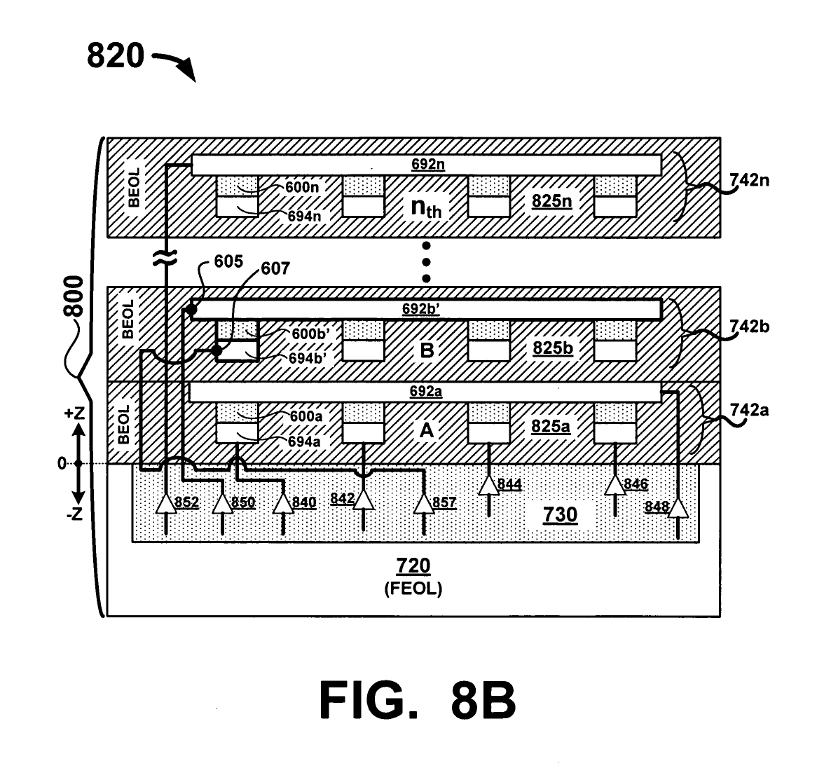

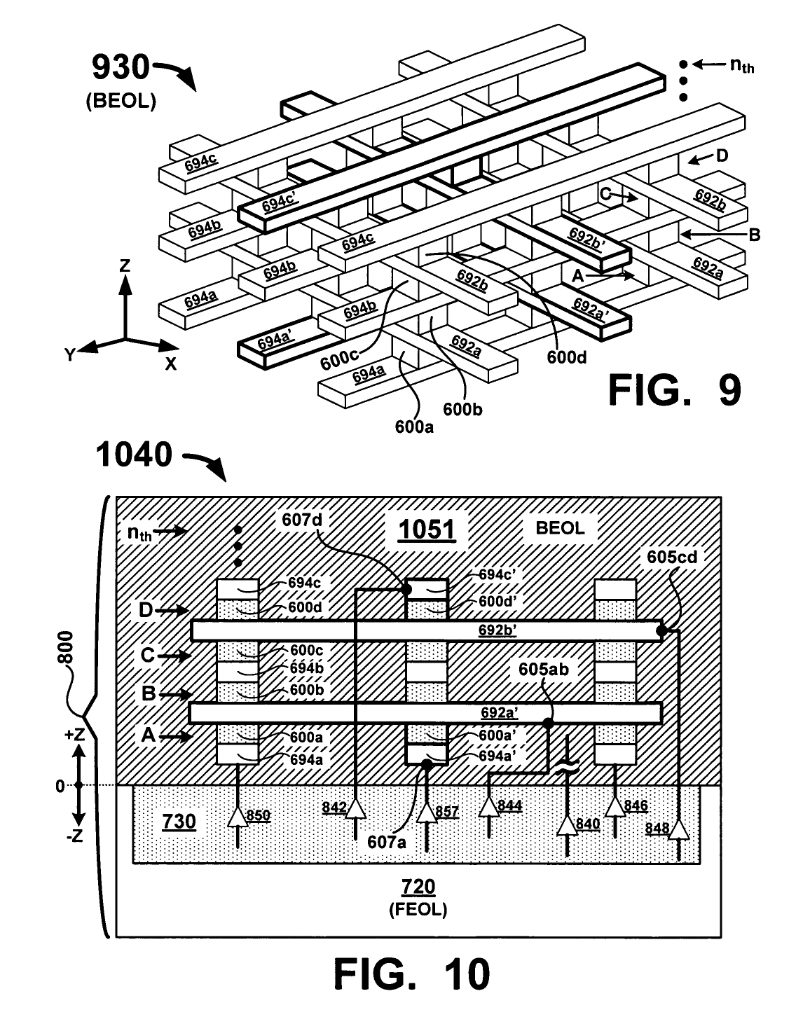

Although only a single layer of memory 712 is depicted in FIG. 8A, additional layers of memory (e.g., 742a-742n) can be vertically fabricated BEOL above an upper surface 692t of conductive array line 692 to form a multi-layer cross-point memory array. The vertically stacked layers of memory can have electrically isolated conductive array lines as depicted in FIGS. 6-8A or can have shared conductive array lines as depicted in FIGS. 9, and 10.

Turning now to FIG. 8B, an integrated circuit 820 includes a plurality of non-volatile memory arrays 742a, 742b, 742n that are vertically stacked above one another (e.g., along the +Z axis) and are positioned above the base layer 720 that includes the active circuitry 730. Collectively, the FEOL base layer 720 and the plurality of non-volatile BEOL memory arrays 742a, 742b, . . . 742n can be referred to as a die 800. The integrated circuit 820 includes vertically stacked memory layers A and B and may include additional memory layers up to an nth memory layer. The memory layers A, B, . . . through the nth layer can be electrically coupled with the active circuitry 730 in the base layer 720 by an inter-level interconnect structure as was described above. Layer A includes memory cells 600a and first and second conductive array lines (692a, 694a), Layer B includes memory cells 600b and first and second conductive array lines (692b, 694b), and if the nth layer is implemented, then the nth layer includes memory cells 600n and first and second conductive array lines (692n, 694n). Dielectric materials 825a, 825b, and 825n (e.g., SiO₂) may be used where necessary to provide electrical insulation between the memory layers and memory elements of the integrated circuit 820. Active circuits 840-857 can be configured to apply the select voltage potentials (e.g., read and write voltage potentials) to selected conductive array lines (e.g., 692a, b, n, and 694a, b, n). Driver circuits 850 and 857 are activated to select conductive array lines 692′ and 694′ to select memory cell 600b′ for a data operation. As was described above, the active circuits 730 can be used to sense the read current I_{R} from selected memory cells 600b′ during a read operation and can be configured to apply the un-select voltage potential to the un-selected array lines.

Attention is now directed to FIG. 9, where a vertically stacked array 930 includes a plurality of memory layers A, B, C, and D with each memory layer including memory cells 600a, 600b, 600c, and 600d. Although only four layers are depicted, the array 930 can include additional layers up to an nth layer. The array 930 includes two levels of x-direction conductive array lines 692a and 692b, and three levels of y-direction conductive array lines 694a, 694b, and 694c. In contrast to the integrated circuit 820 depicted in FIG. 8B where each array layer is electrically isolated from other layers by a dielectric material (825a, 825b, . . . 825n), each memory cell 600a, 600b, 600c, and 600d shares a conductive array line with other memory cells that are positioned above, below, or both above and below that memory cell. Conductive array lines 692a′ and 694a′ select a memory cell 600a′ for a data operation, and conductive array lines 692b′ and 694c′ select a memory cell 600d′ for a data operation (see FIG. 10).

In FIG. 10, an integrated circuit 1040 includes base layer 720, active circuitry 730, and vertically staked memory layers A, B, C, and D that are fabricated above the base layer 720. Collectively, the FEOL base layer 720 and the plurality of non-volatile BEOL memory layers A, B, C, and D can be referred to as a die 800. Active circuits 840-857 are configured to perform data operations on the vertically staked memory layers A, B, C, and D. Driver circuits 844 and 857 are activated to select memory cell 600a′ for a data operation and driver circuits 842 and 848 are activated to select memory cell 600d′ for a data operation. A dielectric layer 1051 is operative to electrically isolate the various components of integrated circuit 1040.

Reference is now made to FIG. 11, where a top plan view depicts a single wafer (denoted as 1170 and 1170′) at two different stages of fabrication: FEOL processing on the wafer denoted as 1170 during the FEOL stage of processing where active circuitry 730 is formed; followed by BEOL processing on the same wafer denoted as 1170′ during the BEOL stage of processing where one or more layers of non-volatile memory are formed. Wafer 1170 includes a plurality of the base layer die 720 (see 720 in FIG. 7) formed individually on wafer 1170 as part of the FEOL process. As part of the FEOL processing, the base layer die 720 may be tested 1172 to determine their electrical characteristics, functionality, performance grading, etc. After all FEOL processes have been completed, the wafer 1170 is optionally transported 1104 for subsequent BEOL processing (e.g., adding one or more layers of memory such as single layer 712 or multiple layers 742a, 742b, . . . 742n) directly on top of each base layer die 720. A base layer die 720 is depicted in cross-sectional view along a dashed line FF-FF where the substrate the die 720 is fabricated on (e.g., a silicon Si wafer) and its associated active circuitry 730 are positioned along the Z axis. For example, the one or more layers of memory are grown directly on top of an upper surface 720s of each base layer die 720 as part of the subsequent BEOL processing.

During BEOL processing the wafer 1170 is denoted as wafer 1170′, which is the same wafer subjected to additional processing to fabricate the memory layer(s) directly on top of the base layer die 720. Base layer die 720 that failed testing may be identified either visually (e.g., by marking) or electronically (e.g., in a file, database, email, etc.) and communicated to the BEOL fabricator and/or fabrication facility. Similarly, performance graded base layer die 720 (e.g., graded as to frequency of operation) may identified and communicated to BEOL the fabricator and/or fabrication facility. In some applications the FEOL and BEOL processing can be done by the same fabricator or performed at the same fabrication facility. Accordingly, the transport 1104 may not be necessary and the wafer 1170 can continue to be processed as the wafer 1170′. The BEOL process forms the aforementioned memory layer(s) directly on top of the base layer die 720 to form a finished die 800 (see die 800 in FIGS. 8A, 8B, and 10) that includes the FEOL circuitry portion 720 along the Z axis and the BEOL memory portion along the +Z axis (see FIGS. 8A-10). A cross-sectional view along a dashed line BB-BB depicts a memory device die 800 with a single layer of memory 712 grown (e.g., fabricated) directly on top of base die 720 along the +Z axis, and alternatively, another memory device die 800 with three vertically stacked layers of memory 742a, 742b, and 742c grown (e.g., fabricated) directly on top of base die 720 along the +Z. Finished die 800 on wafer 1170′ may be tested 1174 and good and/or bad die identified. Subsequently, the wafer 1170′ can be singulated 1178 to remove die 800 (e.g., die 800 are precision cut or sawed from wafer 1170′) to form individual memory device die 800. The singulated die 800 may subsequently be packaged 1179 to form integrated circuits 1190 for mounting to a PC board or the like, as a component in an electrical system (not shown). Here a package 1181 can include an interconnect structure 1187 (e.g., pins, solder balls, or solder bumps) and the die 800 mounted in the package 1181 and electrically coupled 1183 with the interconnect structure 1187 (e.g., using wire bonding). The integrated circuits 1190 (IC 1190 hereinafter) may undergo additional testing 1185 to ensure functionality and yield.

One or more of the IC's 1190 can be used in systems including but not limited to data storage systems, a system that requires dual-port memory, a system requiring non-volatile memory, a system requiring emulation of one or more memory types as described above. Unlike conventional FLASH non-volatile memory, the IC's 1190 do not require an erase operation prior to a write operation so the latency associated with the erase operation is eliminated and the latency associated with FLASH OS and/or FLASH file system required for managing the erase operation and/or other FLASH operations are eliminated.

The foregoing examples have been described in some detail for purposes of clarity of understanding, but are not limited to the details provided. There are many alternative ways and techniques for implementation. The disclosed examples are illustrative and not restrictive.

What is claimed is:

1. A memory system, comprising:
a first memory operative to emulate a first memory type, the first memory configured in a back-end-of-the-line (BEOL) third dimensional memory array, and the BEOL third dimensional memory array is in contact with and is fabricated directly above a component;
a second memory operative to emulate a second memory type, the second memory configured in the BEOL third dimensional memory array; and
an interface configured to access data in the first memory or the second memory.

2. The memory system of claim 1 and further comprising: a front-end-of-the-line (FEOL) interface logic electrically coupled with the first memory and the second memory.

3. The memory system of claim 2, wherein the FEOL interface logic comprises control logic configured to control the first memory and the second memory.

4. The memory system of claim 2, wherein the FEOL interface logic comprises a first control logic configured to control the first memory and a second control logic configured to control the second memory.

5. The memory system of claim 2, wherein the FEOL interface logic comprises address decoder logic configured to receive an address from a host.

6. The memory system of claim 2, wherein the FEOL interface logic comprises controller logic configured to receive data from an external port.

7. The memory system of claim 2 and further comprising: a plurality of interface pins configured to electrically couple a host with the FEOL interface logic.

8. The memory system of claim 7, wherein at least one of the plurality of interface pins comprises a data pin configured to receive data from the host and to transmit data from the first memory and the second memory.

9. The memory system of claim 7, wherein at least one of the plurality of interface pins comprises a pin configured to receive a signal indicating whether the first memory or the second memory is in a read state or a write state.

10. The memory system of claim 7, wherein at least one of the plurality of interface pins comprises a chip select pin configured to select the first memory or the second memory for access.

11. The memory system of claim 7, wherein at least one of the plurality of interface pins comprises a pin configured to receive an address from the host.

12. The memory system of claim 7, wherein at least one of the plurality of interface pins comprises at least a portion of a bus configured to receive an address from the host.

13. The memory system of claim 7, wherein at least one of the plurality of interface pins comprises a clock pin configured to receive a clock signal.

14. The memory system of claim 7, wherein at least one of the plurality of interface pins comprises a DMA port configured to receive data from an external source.

15. The memory system of claim 2, wherein the FEOL interface logic is formed in a plane that is in contact with and vertically positioned below the BEOL third dimensional memory array and the first memory is formed in another plane of the BEOL third dimensional memory array.

16. The memory system of claim 2, wherein the FEOL interface logic is formed in a plane that is in contact with and vertically positioned below the BEOL third dimensional memory array and the second memory is formed in another plane of the BEOL third dimensional memory array.

17. The memory system of claim 1, wherein the first memory type emulates NAND Flash memory and the second memory type emulates NOR Flash memory.

18. The memory system of claim 1, wherein the first memory type emulates NOR Flash memory and the second memory type emulates DRAM.

19. The memory system of claim 1, wherein the first memory type emulates SRAM and the second memory type emulates DRAM.

20. The memory system of claim 1 and further comprising: a third memory operative to emulate a third memory type and positioned in the BEOL third dimensional memory array.

21. The memory system of claim 20, wherein the first memory type emulates SRAM, the second memory type emulates NOR Flash memory, and the third memory type emulates NAND Flash memory.

22. The memory system of claim 20, wherein the first memory type emulates SRAM, the second memory type emulates NOR Flash memory, and the third memory type emulates DRAM.

23. The memory system of claim 1, wherein the first memory and the second memory are formed in a non-volatile two-terminal cross-point memory array that includes one or more planes vertically disposed over one another.

24. A system, comprising:
a first memory operative to emulate a first memory type;
a second memory operative to emulate a second memory type, wherein the first memory and the second memory are positioned in a back-end-of-the-line (BEOL) non-volatile two-terminal cross-point memory array; and
an interface including active circuitry in electrical communication with the BEOL non-volatile two-terminal cross-point memory array and configured to access the first memory and the second memory, wherein the interface is configured to provide direct or indirect access to the first memory or the second memory.

25. The system of claim 24, wherein the first memory or the second memory are accessible for data operations using a DMA controller.

26. The system of claim 24, the first memory or the second memory is accessible for data operations using a port.

27. The system of claim 24, wherein the first memory type or the second memory type emulates NOR Flash memory.

28. The system of claim 24, wherein the first memory type or the second memory type emulates SRAM.

29. The system of claim 24, wherein the first memory type or the second memory type emulates ROM.

30. The system of claim 24, wherein the first memory type or the second memory type emulates ROM, wherein a write access to the first memory or the second memory is blocked after the first memory or the second memory is initially written.

31. The system of claim 24, wherein the interface is configured to be shared between the first memory and the second memory.

32. The system of claim 24, wherein the interface further comprises a first interface configured to provide access to the first memory and a second interface configured to provide access to the second memory.

33. The system of claim 24, wherein the interface further comprises an address memory, the address memory being configured to identify the first memory or the second memory when an access is requested.

34. The system of claim 33 and further comprising: logic configured to control emulation of the first memory type or the second memory type based on the access requested.

35. The system of claim 24, wherein the active circuitry is fabricated front-end-of-the-line (FEOL) and positioned on a substrate, and the BEOL non-volatile two-terminal cross-point memory array is in contact with the substrate and vertically positioned above the substrate.
